(19) United States
(12) Patent Application Publication
(10) Pub. No.: US 2006/0162987 A1
(43) Pub. Date: Jul. 27, 2006

(54) Steering angle-restricted steering systems

(76) Inventor: Bernhard Hagl, Hang an der Amper (DE)

Correspondence Address: EDWARDS & ANGELL, LLP, P.O. BOX 55874, BOSTON, MA, 02205, US

(21) Appl. No.: 10/538,959

(22) PCT Filed: Sep. 7, 2004
(86) PCT No.: PCT/EP04/09969

§ 371 Date: Jun. 14, 2005

(30) Foreign Application Priority Data
Sep. 10, 2003 (DE) 103 41 808.3

(51) Int. Cl. B62D 7/09

(52) U.S. Cl. 180/411

(57) ABSTRACT

A steering system has a wheel (38) which rolls on an underlying surface (U) and which can be steered about a wheel steering axis (34) which is orthogonal with respect to the underlying surface (U), the rolling direction being determined by a wheel steering angle which describes the rotational position of the wheel (38) about the wheel steering axis (34). Furthermore, the steering system has a steering force coupling-in part (13) for coupling a steering force into the steering system and a steering force transmission device (28) for transmitting the steering force to the wheel (38), and, furthermore, a steering angle limiting device (40, 42a, 42b, 50) which can be switched between an active state and an inactive state, limits the wheel steering angle at least to a wheel steering angle range in the active state and does not limit the wheel steering angle of the wheel (38) in the inactive state. According to the invention, the steering angle limiting device (40, 42a, 42b, 50) comprises a brake (40) which, in the active state of the steering angle limiting device (40, 42a, 42b, 50), generates a brake force which limits a rotation of the wheel (38) about the wheel steering axis (34) to the predefined wheel steering angle range.

The present invention relates to a steering system having at least one wheel which rolls on an underlying surface in a direction parallel to the underlying surface and which can be steered about a wheel steering axis which is substantially orthogonal with respect to the underlying surface, the rolling direction being determined by a wheel steering angle which describes the rotational position of the at least one wheel about the wheel steering axis, having a steering force coupling-in part for coupling a steering force into the steering system and having a steering force transmission device for transmitting the steering force to the at least one wheel, in order to bring about a change in the wheel steering angle of the at least one wheel, the steering system furthermore comprising a steering angle limiting device which can be switched between an active state and an inactive state, limits the wheel steering angle at least to a wheel steering angle range in the active state and does not limit the wheel steering angle of the at least one wheel in the inactive state. Furthermore, the invention relates to an industrial truck, in particular an industrial truck with automatic steering, having a steering system of this type.

A steering system of this type having a mechanical steering angle limiting device is already known. In the case of the mechanical steering angle limiting device, a locking mandrel is moved with a form-fitting fit into a recess in a steering shaft in the active state of said mechanical steering angle limiting device. Here, the recess can have somewhat greater dimensions than the locking mandrel, with the result that there is a certain amount of steering play. However, this steering play is not sufficient to steer a vehicle which is equipped with the steering system into a bend. For this reason, the locking mandrel has to be disengaged from the recess in the steering shaft while driving around corners. The steering shaft is thus released for any desired rotation. It is, however, not possible to switch back into the active state while driving around corners, as the locking mandrel and the steering shaft recess are no longer aligned on account of the steering rotation of the steering shaft.

The known steering angle limiting device is used, above all, in industrial trucks with automatic steering and ensures that a system failure of the steering system while driving in a straight line does not lead to an excessive deviation of the travel path of the vehicle from the desired travel path. This is true, in particular, for the braking path in the case of an emergency braking operation which is initiated if the steering system fails.

Satisfactory results are achieved with the known system on straight driving sections. However, as the known steering system requires the inactive state of the steering angle limiting device for driving around corners, the result in the event of an emergency braking operation while driving around a corner can be an uncontrolled deviation of the travel path of the vehicle from the desired travel path. This is the case, in particular, if the steerable wheel collides with obstacles and an undesirable change in the wheel steering angle is caused by force jolts or the like. As a consequence, collisions of the vehicle are possible with objects on the sides of the desired travel path.

It is therefore an object of the present invention to specify a steering system of the type mentioned in the introduction, which steering system reduces the risk of a collision of a vehicle which is equipped with the steering system with objects near the desired travel path, even when driving around a corner, in particular in the event of an emergency braking operation.

According to the invention, this object is achieved by a steering system of the generic type, in which steering system the steering angle limiting device comprises a brake which is provided in such a way that, in the active state of the steering angle limiting device, it generates a brake force which limits a rotation of the at least one wheel about the wheel steering axis to the predefined wheel steering angle range and it does not generate a brake force of this type in the inactive state of the steering angle limiting device.

The steering angle limiting device can also be switched while driving around a corner from the inactive state into the active state as a result of the use of a brake, as the steering angle is no longer limited with a form-fitting fit but with a force-transmitting fit, with the result that, in particular in the event of an emergency braking operation and a simultaneous switchover from the inactive state into the active state, the at least one steerable wheel can still achieve only a wheel steering angle within a predefined wheel steering angle range, which ensures that the travel path or the brake path coincides at least approximately with the desired travel path. As a result, the risk of a collision with objects near the desired travel path is reduced.

“Wheel steering angle” means the angle which a center plane of the at least one steerable wheel includes with a plane which is orthogonal with respect to the local underlying surface and comprises a preferred direction. Here, the local underlying surface of the wheel denotes a sliding square plane to the underlying surface at the point of wheel contact. The preferred direction is the straight ahead driving direction and defines a steering angle of zero degrees. As a rule, the longitudinal direction of a vehicle which is equipped with the steering system according to the invention is used as the preferred direction.

The direction “parallel to the underlying surface” denotes a direction which is parallel to the underlying surface at the respective point of wheel contact of the at least one wheel.

It goes without saying that the at least one wheel can also be rotated for steering purposes about a steering shaft which runs obliquely with respect to the respective underlying surface. However, a rotation of this type also has a rotational axis component which is orthogonal with respect to the underlying surface. This rotational axis component is then denoted by the wheel steering axis which is substantially orthogonal with respect to the underlying surface.

The steering force coupling-in part can be, for example, a flange or a coupling device for coupling a force unit, or else a steering wheel or steering joystick for the manual exertion of a steering force.

Furthermore, the solution of the abovementioned object is not to be understood in the sense that the brake has absolutely no braking effect in the inactive state of the steering angle limiting device. Rather, it is sufficient for the braking effect not to be sufficiently large as to bring about steering angle limitation. This is intended to include the case where any brake disks which might be present but are ventilated still generate a minimum braking effect by random friction.

When it is said that the wheel steering angle is limited at least to a wheel steering angle range, this is also intended to encompass the case of a concrete wheel steering angle, in addition to a wheel steering angle range which is defined between limiting wheel steering angles. Furthermore, the statement that the steering angle limiting device does not limit the wheel steering angle of the at least one wheel in the inactive state is not intended to preclude that the wheel steering angle is limited by other apparatuses or that in general a steering system is provided on the respective vehicle only in a limited wheel steering angle range. Rather, this statement means that the steering angle limiting device does not exert a limiting function with regard to the wheel steering angle, irrespectively of the remaining structural configuration.

The slightest risk of a collision of a vehicle which is equipped with the steering system according to the invention with objects near the desired travel path while cornering is present in general when the brake fixes the at least one wheel to the wheel steering angle which is present at the instant of the switchover from the inactive state to the active state. In practice, there is then no longer any steering play, within which the at least one wheel can still be rotated about the wheel steering axis by undesirable force jolts.

As a rule, vehicles are equipped with a large number of different components and systems, with the result that there is only a limited amount of installation space for accommodating an additional component such as a brake. The structural freedom for accommodating the brake in the vehicle can be increased advantageously in that the steering force transmission device comprises a steering shaft which is optionally of multi-part design, and a movement part of the brake which can be braked is connected to the steering shaft in order to transmit torque. In this case, the brake can be connected to the steering shaft at any desired location along the latter. The movement part of the brake denotes a part which is connected to a part which is to be braked and on which a braking force which is generated in conjunction with brake parts which are stationary or fixed to the vehicle frame acts in a braking manner.

In very rare cases, the steering force is introduced into the system in such a way that it can be used without conversion for steering the at least one wheel. If, for example, rapidly rotating steering motors are used, it can be useful for the steering system to comprise a step-down gear mechanism which is connected on the input side to the steering force coupling-in part and on the output side to the at least one wheel. As step-down gear mechanisms denote gear mechanisms which reduce a rotational speed from the input side to the output side according to their step-down gear ratio and accordingly increase the introduced torque from the input side toward the output side, it is favorable to arrange the brake on the input side of the step-down gear mechanism. The structural volume of a brake is proportional to the braking torque which is to be exerted by it, with the result that a brake which is arranged in this way can have smaller dimensions than a brake on the output side of the step-down gear mechanism.

In contrast, cases are also conceivable in which a step-up gear mechanism can be required, in which step-up gear mechanism the rotational speed of the steering shaft is increased from the input side to the output side and the steering torque is reduced accordingly. In a case of this type, it is advantageous for the same reasons as before to arrange the brake on the output side of the step-up gear mechanism.

In principle, the brake can be any desired brake which can generate a braking effect by a force which is caused mechanically and/or electromagnetically and/or electromechanically. However, a proven and commercially available electromagnetic safety brake is preferably used which generates a braking effect in a state in which no current is applied and does not generate a braking effect in a state in which current is applied.

Brakes of this type are friction brakes, in which a helical spring presses a ferromagnetic pressure plate against a movable brake disk. A circumferential radial lamella of the movement part of the brake is arranged between the movable brake disk and a stationary brake disk. When current is applied to the safety brake, current is applied to an electromagnet which thus generates a magnetic field which attracts the ferromagnetic pressure plate counter to the force of the helical springs, with the result that the lamella of the movement part can rotate freely between the brake linings without being clamped by the latter. When no current is applied to the electromagnet, this force of attraction is absent and the pressure plate is pressed against the brake linings by the helical springs, with the result that a braking effect is brought about.

Although consideration can be given to providing the steering system also with a steering wheel or steering horn for manual steering, a human operator is as a rule more capable than an automatic system of avoiding objects in the travel path ahead. Nevertheless, the invention is to expressly include the case that the steering system is a manual steering system or a manual steering system with motor assistance.

The steering system can comprise a steering motor, preferably in the form of an electric motor, which is connected to the steering force coupling-in part in order to transmit torque. In this case, the steering motor can generate a steering torque independently of manual or automatic steering signals. A human operator would be relieved of the need to produce a steering torque by motor assistance of this type and would merely need to stipulate the desired driving direction. A steering motor is imperative as the source of a steering force in a fully automatic steering system which determines a desired travel path via sensors and/or has stored a desired travel path of this type.

If the steering motor is an electric motor, particularly high safety against undesirable collisions can be attained as a result of the fact that the steering angle limiting device switches into the active state if there is a disruption to the steering control system, in particular if there is a disruption to the current supply of the steering angle motor. A disruption to the current supply of the electric steering motor is particularly critical, as virtually no force is opposed by the currentless motor to a rotation of the at least one wheel about the steering axis. This can be attained simply in structural terms, in that the abovementioned electromagnetic safety brake and the electric steering motor are connected to a common energy supply. In this case, when operation of the electric steering motor is no longer ensured, the electromagnetic safety brake is also triggered, with the result that the steering angle limiting device automatically switches into the active state, for instance if the energy supply for the electric steering motor fails.

In one embodiment of the present invention which is particularly advantageous for reasons of the limited installation space available, the brake can be arranged in such a way that a movement part of the brake which can be braked is connected to the motor shaft of the steering motor in order to transmit torque. In this case, the brake can be positioned on the steering motor in the longitudinal direction of the motor shaft. As there is usually a step-down gear mechanism between the motor and the at least one wheel in steering motors, the brake which is connected to the motor shaft can, furthermore, be of comparatively small dimensions compared with other arrangement locations in the steering system.

Steering systems of this type are frequently used in industrial trucks, as they often have to maneuver between a very wide variety of objects in stores or workshops. A steering system according to the invention gives an industrial truck special value, with the result that independent protection is sought for an industrial truck having at least one steerable wheel and a steering system having at least one or more of the abovementioned features. Here, the at least one steerable wheel is the at least one wheel of the steering system.

The use of a steering system according to the invention in an industrial truck with automatic steering is particularly advantageous, as it is not possible here for a correcting steering intervention to be performed by a human operator in the case of an emergency.

Here, industrial trucks with automatic steering have proven to be particularly reliable which follow a course of a conductor loop which is arranged on or under the underlying surface. The course of the conductor loop thus forms the desired travel path of the industrial truck. This course is sensed by antennas and the industrial truck is guided by the steering system in accordance with the sensor results.

In the following text, the present invention will be explained in greater detail using the appended drawings, in which:

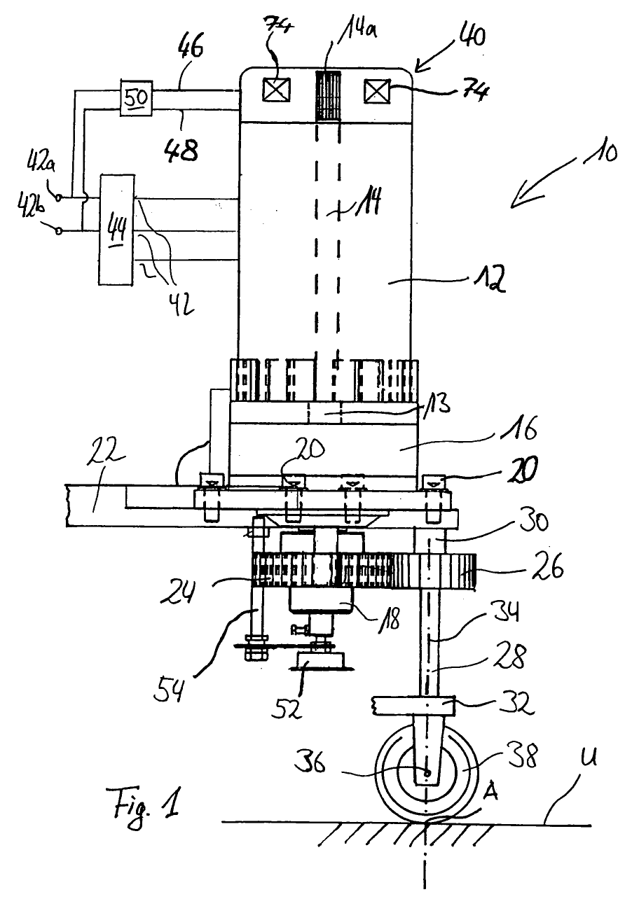

FIG. 1 shows a diagrammatic side view of a preferred embodiment of the steering system according to the invention, and

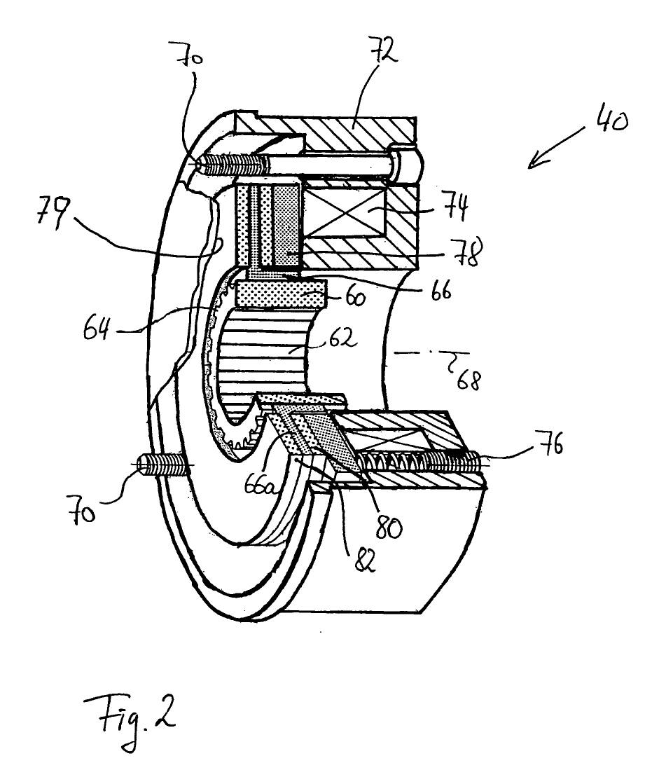

FIG. 2 shows a diagrammatic partially sectional view of the electromagnetic safety brake shown in FIG. 1.

In FIG. 1, an embodiment of the steering system according to the invention is denoted overall by 10. The steering system 10 comprises an electric steering motor 12 which can be, for example, a three-phase asynchronous motor. The motor shaft of the steering motor 12 is shown dashed and is denoted by 14.

On the driven side, that is to say at the bottom in FIG. 1, the steering motor 12 is adjoined via a shaft/hub connection 13 by a step-down gear mechanism 16 which steps down the rotational speed of the steering motor 12 toward slower rotational speeds. On the output side, the step-down gear mechanism 16 has an output shaft journal 18. The assembly comprising the steering motor 12 and the gear mechanism 16 is fastened to a vehicle frame 20 using screws 20.

Furthermore, a spur gear 24 which is seated on the output shaft journal 18 and meshes with a spur gear 26 is fastened rotatably to the vehicle frame 22. The spur gear 26 is arranged on a steering shaft 28 which is mounted at 30 and 32 on the vehicle frame 22 so as to rotate about a steering axis 34. A wheel 38 which is rotatable about a rotational axis 36 orthogonal with respect to the plane of the drawing of FIG. 1 for rolling on an underlying surface U is connected to the steering shaft 28.

In the example shown in FIG. 1, the steering axis 34 and the rotational axis 36 intersect, but this is not necessary. The steering axis 34 is substantially orthogonal with respect to the plane of wheel contact, that is to say with respect to a tangential plane to the underlying surface U at the wheel contact point A.

By rotation of the motor shaft 14 and thus of the transmission output shaft journal 18, the spur gear 24 and finally the further spur gear 26 are rotated and the wheel steering angle of the wheel 38 is thus changed. The steering motor 12 can be driven in both directions, with the result that it is possible to rotate the steering shaft 28 about the steering axis 34 in both directions of rotation.

An electromagnetic safety brake 40 is arranged at that longitudinal end of the steering motor 12 which is remote from the step-down gear mechanism 16. The basic construction and method of operation of the electromagnetic safety brake 40 will be explained further below in conjunction with FIG. 2.

At its longitudinal end 14a which is remote from the step-down gear mechanism 16, the motor shaft 14 has a splined shaft profile, by means of which the motor shaft 14 is connected to the safety brake 40 in order to transmit torque.

The steering motor 12 is connected to a motor control unit 44 which comprises an inverter for a three-phase current supply 42 of the steering motor. The motor control unit 44 is supplied with electricity from the onboard battery via the lines 42a, 42b. The electromagnetic safety brake 40 which is actuated by quiescent current is likewise connected via two supply lines 46 and 48 and a brake control unit 50 to the vehicle-mounted electrical system which is fed from the vehicle battery.

In addition, reference is made in FIG. 1 to an actual rotational position sensor 52 which detects the actual rotational position of the output shaft journal 18 of the step-down gear mechanism 16 and transmits it to a control device (not shown). The actual rotational position sensor 52 is supported on the vehicle frame 22 via a torque support 54.

FIG. 2 shows an example of an embodiment of the electromagnetic safety brake 40 which is actuated by quiescent current and is indicated in FIG. 1.

A movement part 60 can be connected via an inner splined shaft profile 62 to the splined tooth profile at the longitudinal end 14a of the motor shaft 14 of the steering motor.

The movement part 60 is connected via an outer splined shaft profile 64 to a lamellar body (rotor) 66 in such a way that the latter can be displaced in the direction of the axis 68. The rotor 66 has frictional brake linings 80, 82.

The safety brake 40 can be connected to the steering motor 12 via screws 70. The heads of the screws 70 are supported on the brake body 72. An electromagnet 74 is recessed in the brake body 72 and is connected to the current source via the supply lines 46 and 48, as shown in FIG. 1.

Moreover, helical springs 76 are embedded in the brake body 72, which press against the armature disk 78 in the direction of the axis 68.

If current is supplied to the electromagnet 74, it generates a magnetic field which attracts the armature disk 78 counter to the force of the spiral springs 76, with the result that the rotor 66 and the movement part 60 connected to the latter in order to transmit torque can rotate substantially freely. If, in contrast, the current supply to the electromagnet 74 fails, the magnetic field which is generated by it disappears and the helical springs 76 press the armature disk 78 against the brake lining disk 80 in the direction of the axis 68. As a result, the rotor 66 with the brake lining disks 80 and 82 is clamped between the armature disk 78 and a mounting surface 79 of the brake 40 which is shown only partially in FIG. 1, with the result that a braking torque acts via the rotor 66 and the movement part 60 on the motor shaft 14 which is connected to the movement part 60.

The instantaneous rotational position of the motor shaft 14 and thus the instantaneous steering angle of the wheel 38 can be fixed using the electromagnetic safely brake 40, for instance in the event of a power failure in the lines 42a, 42b. Without a safety brake, the wheel 38 could be rotated without significant resistance about the steering axis 34 if the steering motor 12 were currentless, which can lead to a deviation of the vehicle equipped with the steering system 10 if the motor 12 is currentless. The safety brake 40 prevents the steering angle of the wheel 38 from changing, as soon as the current supply to the electromagnet 74 ends.

The steering system is particularly safe when the safety brake 40 is dimensioned in such a way that its braking torque exceeds the drive torque of the motor. The safety brake can then become active even if current is being supplied to the motor.

1. A steering system having at least one wheel which rolls on an underlying surface (U) in a direction parallel to the underlying surface and which can be steered about a wheel steering axis which is substantially orthogonal with respect to the underlying surface (U), the rolling direction being determined by a wheel steering angle which describes the rotational position of the at least one wheel about the wheel steering axis, having a steering force coupling-in part for coupling a steering force into the steering system and having a steering force transmission device for transmitting the steering force to the at least one wheel, in order to bring about a change in the wheel steering angle of the at least one wheel, the steering system furthermore comprising a steering angle limiting device which can be switched between an active state and an inactive state, limits the wheel steering angle at least to a wheel steering angle range in the active state and does not limit the wheel steering angle of the at least one wheel in the inactive state, wherein the steering angle limiting device comprises a brake which is provided in such a way that, in the active state of the steering angle limiting device, it generates a brake force which limits a rotation of the at least one wheel about the wheel steering axis to the predefined wheel steering angle range and it does not generate a brake force of this type in the inactive state of the steering angle limiting device.

2. The steering system as claimed in claim 1, wherein the brake fixes the at least one wheel to the wheel steering angle which is present at the instant of the switchover from the inactive state to the active state.

3. The steering system as claimed in claim 1, wherein the steering force transmission device comprises a steering shaft which is optionally of multi-part design, and a movement part of the brake which can be braked is connected to the steering shaft in order to transmit torque.

4. The steering system as claimed in claim 1, further comprising a step-down gear mechanism which is connected on the input side to the steering force coupling-in part and on the output side to the at least one wheel, the brake being arranged on the input side of the step-down gear mechanism.

5. The steering system as claimed in claim 1, further comprising a step-up gear mechanism which is connected on the input side to the steering force coupling-in part and on the output side to the at least one wheel, the brake being arranged on the output side of the step-up gear mechanism.

6. The steering system as claimed in claim 1, wherein the brake is an electromagnetic safety brake which generates a braking effect in a state in which no current is applied and does not generate a braking effect in a state in which current is applied.

7. The steering system as claimed in claim 1, further comprising a steering motor in the form of an electric motor, which is connected to the steering force coupling-in part in order to transmit torque.

8. The steering system as claimed in claim 6, wherein the steering motor is an electric motor and the steering angle limiting device switches into the active state if there is a disruption to the current supply of the steering motor.

9. The steering system as claimed in claim 8, wherein the electromagnetic safety brake and the electric steering motor are connected to a common energy supply.

10. The steering system as claimed in claim 7, wherein a movement part of the brake which can be braked is connected to the motor shaft of the steering motor in order to transmit torque.

11. An industrial truck having at least one steerable wheel and a steering system which is connected to this wheel and is as claimed in claim 1.

12. The industrial truck as claimed in claim 11, wherein the industrial truck is an industrial truck with automatic steering.

13. The industrial truck as claimed in claim 12, wherein the industrial truck is an industrial truck with automatic steering and follows a course of a conductor loop which is arranged on or under the underlying surface.
